(19) United States
(12) Patent Application Publication
(10) Pub. No.: US 2014/0222382 A1
(43) Pub. Date: Aug. 7, 2014

(54) APPARATUS AND METHOD FOR REMOVING NOISE FROM A BIOELECTRICAL SIGNAL

(71) Applicant: MOLECULAR DEVICES, LLC, Sunnyvale, CA (US)

(72) Inventors: Parag Patel, Livermore, CA (US); Michael Youngquist, Palo Alto, CA (US)

(73) Assignee: MOLECULAR DEVICES, LLC, Sunnyvale, CA (US)

(21) Appl. No.: 13/757,604

(22) Filed: Feb. 1, 2013

(51) Int. Cl. H04B 1/10

(52) U.S. Cl. CPC H04B 1/1027
USPC 702/191

(57) ABSTRACT

A method and apparatus for removing noise from a bioelectrical signal are provided. A main analog signal from a bioelectrical test probe and a gating signal are received. A main data stream associated with the main analog signal from the bioelectrical test probe is developed. An adaptive noise cancellation (ANC) unit operates to develop an output data stream by removing noise components from the main data stream in accordance with the reference data stream. If the gating signal indicates that the main analog signal was acquired during a period of bioelectrical activity then the ANC unit operates in a fixed mode, and if the gating signal indicates that the main analog signal was acquired during a period without bioelectrical activity then ANC unit operates in an adaptive mode.

### TECHNICAL FIELD

The present invention relates generally to a system for adaptive noise cancellation in a digitizer, and more particular a system for cancellation of noise in signals that may include high-speed transient or non-periodic components such as, for example, a bioelectrical signal.

### BACKGROUND

Certain biological experiments involve measurement and analysis of a bioelectrical signal generated by a cell or cell membrane. Such bioelectrical signals may be naturally generated in the cell, for example, during open or closed ion-channel activity or be generated in response to a stimulus supplied to a membrane of the cell or a part of such membrane. Such stimulation may be electrical stimulation or may be an addition of a chemical compound or a change in the environment of the cell. The bioelectrical signal is sensed by a microelectrode as a change in an electrical characteristic such as electrical impedance, voltage, or current. Typically, an analog signal provided by the microelectrode is sampled to generate values of a digital data stream that represents the analog signal. Such digital data stream may be processed prior to analysis to remove noise components present in the values that comprise the digital data stream.

A signal from a bio electrical source in response to a stimulus typically includes rapid transitions in electrical characteristics. Further, such signals may be susceptible to electrical noise from other electrical equipment operating in a vicinity of microelectrode. The noise from such electrical equipment is generally periodic at a frequency identical to the local power source (e.g., 60 Hz in the United States and 50 Hz in most of the other parts of the world) and its harmonics. Although typical adaptive noise cancellation (ANC) units can be used to filter such electrical noise from the bioelectrical signal, such typical ANC units may react to the rapid transition in the bioelectrical signal and, as a result may attempt to remove the frequency components associated with such transitions that are within bandwidth of the ANC unit. Such attempted removal of the frequency components that are associated with fast transitions can introduce artifacts in the output of the ANC unit until the ANC adapts to the transitioned state of the signal.

### SUMMARY

A method of removing noise from a bioelectrical signal is provided. A main analog signal from a bioelectrical test probe and a gating signal are received. The method includes further steps of developing a main data stream associated with the main analog signal from the bioelectrical test probe and developing an output data stream by removing estimated noise components from the main data stream. The method also includes the step of updating the estimated noise components in accordance with the main signal only if the gating signal indicates that the main analog signal was acquired during a period without bioelectrical activity.

An apparatus for removing noise from a bioelectrical signal is also provided. The apparatus includes a main analog-to-digital converter (ADC) unit that develops a main data stream from a main analog signal received from a bioelectrical test probe. The apparatus also includes a gating module that receives a gating signal and an adaptive noise cancellation (ANC) unit. The ANC unit develops an output data stream by removing estimated noise components from the main data stream and updates the estimated noise components in accordance with the main signal only if the gating signal indicates that the main analog signal was acquired during a period without bioelectrical activity.

Other aspects and advantages will become apparent upon consideration of the following detailed description.

### BRIEF DESCRIPTION OF THE DRAWINGS

FIG. 1 is a system diagram of a system to acquire and process bioelectrical signals;

FIG. 2 is a system diagram of an embodiment of a digitizer of the system of FIG. 1;

FIG. 3 is a system diagram of a gating module of the embodiment of the digitizer of FIG. 2;

FIG. 4A is a system diagram of an embodiment of a reconstruction module of the embodiment of the digitizer of FIG. 2;

FIG. 4B is a system diagram of another embodiment of a reconstruction module of the embodiment of the digitizer of FIG. 2;

FIG. 5A is a flowchart of processing undertaken by an embodiment of a controller of the system of FIG. 1;

FIG. 5B is a flowchart of processing undertaken by an embodiment of a controller of the system of FIG. 1;

FIG. 6 graphical depicts noise removal by an ANC unit of the embodiment of the digitizer of FIG. 2; and

FIG. 7 is a flowchart of an embodiment of an ANC unit of the embodiment of the digitizer of FIG. 2.

### DETAILED DESCRIPTION

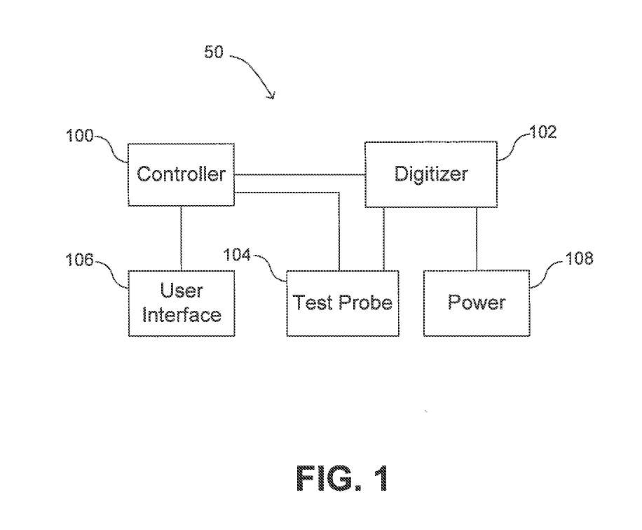

Referring to FIG. 1, a bioelectrical signal acquisition system 50 includes a controller 100, a digitizer apparatus 102, and a test probe 104 such as, for example, a microelectrode. In addition, a user interface 106 of the bio electrical signal acquisition system allows a user to provide acquisition parameters to the controller 100. A power source 108 provides line power to the digitizer 102 and, if necessary, other components of the bioelectrical signal acquisition system. Typically, the controller 100 directs the test probe 104 to begin acquisition of a signal from a test sample, such as a cell, and the acquired signal is provided to the digitizer 102. The digitizer 102 converts the analog signal from the test probe 104 into values of a digital data stream. It should be apparent to those having skill that one or more intermediate devices (not shown), for example an amplifier, may receive and modify the signal from the test probe 104 before the digitizer 102 receives such modified signal. Such modified signals are described herein as being received from the test probe 104. Further, the digitizer 102 may process the values of the digital data stream, for example, to develop an estimate of electrical noise in the original signal and to filter noise components that may be present in the digital data stream.

In one embodiment, the controller 100 may supply to the digitizer 102 a gating signal that indicates whether the analog signal from the test probe 104 is the result of bioelectrical activity in the sample and may have rapid transitions or high frequency bioelectrical components therein. If the gating signal indicates that the signal acquired from the test probe 104 may include components due to bioelectrical activity, the noise cancellation circuitry of the digitizer 102 does not include such signals to update an estimate of the noise to be filtered from the signals from the test probe. Alternately, if the gating signal indicates that such signal does not include components associated with bioelectrical activity, such signal is used to update an estimate of the noise present in the signals from the test probe 104. Such estimate of noise is updated in substantially real time and used to remove noise components from the digital data stream developed from the signal from the test probe 104, regardless of whether the test probe 104 captured such signal during a period of bioelectrical activity or during a period without bioelectrical activity. Not including signals generated during periods of the bioelectrical activity in estimates of noise, as described above, prevents the rapid transitions and frequency distributions present in such signals from corrupting the noise estimate and thereby introducing unwanted artifacts in the output of the digitizer 102.

After the digital data stream is processed to filter noise therefrom, the digitizer 102 provides such processed data stream to the controller 100 or other devices (not shown) for display to an operator or for further analysis.

In some embodiments, the digitizer 102 may have several input channels and each input channel may be associated with a test probe 104 or other signal source. In some embodiments, the digitizer 102 may simultaneously remove noise from separate digital data streams, wherein each such stream is the result of sampling the analog signal provided by a test probe 104 or other signal source over a particular input channel of the digitizer 102. Further, in some embodiments, the user may indicate via the controller 100 whether the digitizer is to remove noise from the fundamental frequency of the signal provided by the test probe 104 or other signal source, one or more harmonic frequency of such signal, or a combination thereof.

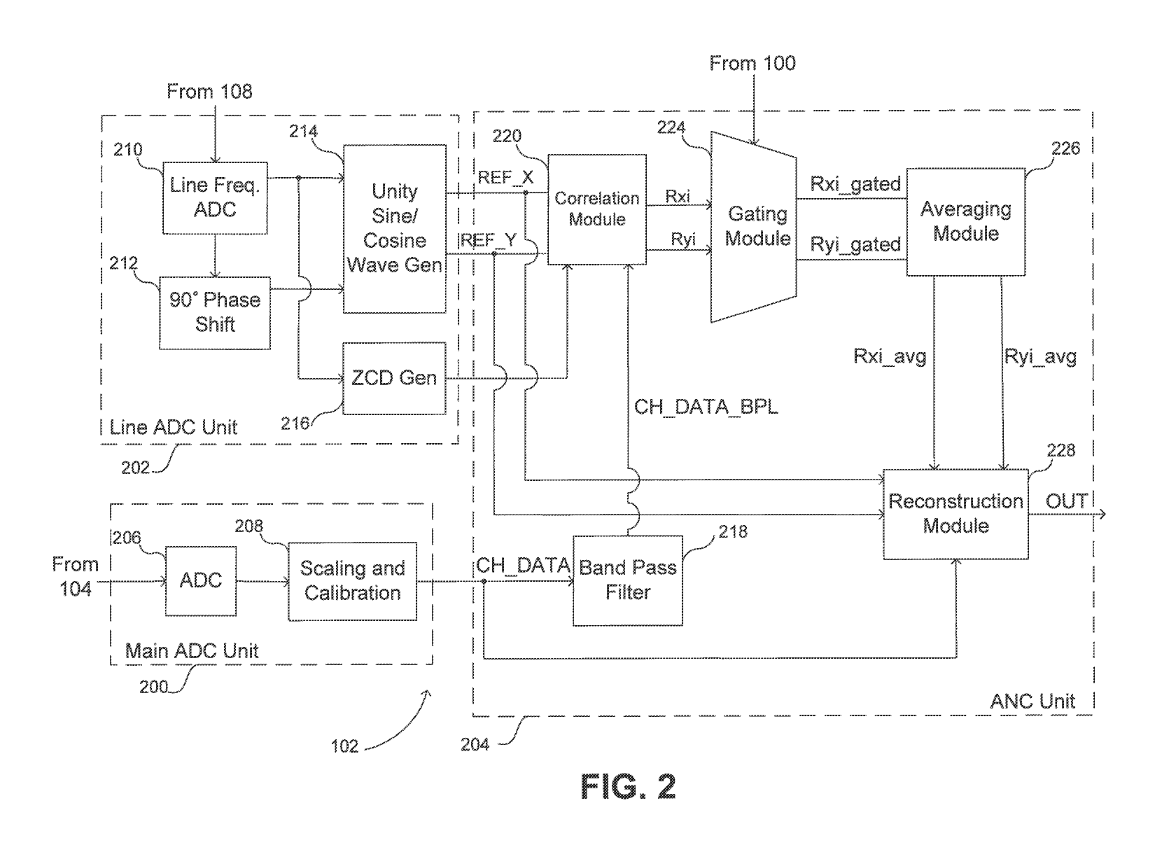

Referring to FIG. 2, one embodiment of a digitizer 102 includes a main analog-to-digital (ADC) unit 200, a line ADC unit 202, and an ANC unit 204. The main ADC unit 200 samples the analog signal from a test probe 104 to produce values of a digital data stream. The line ADC unit 202 samples a signal from a power source 108 to generate values of digital data streams that represent reference signals.

In particular, an ADC module 206 of the main ADC unit 200 continuously samples the signal provided by one or more test probes 104 to the digitizer 102. In some embodiments, the ADC module 206 may be a 16-bit ADC and sample the analog signal at 500K samples-per-second (KSPS). It should be apparent that the ADC module 206 may be configured to sample at various rates and/or generate values of different bit-lengths. In some embodiments, the operator may select the input channels for noise filtering and the signal received over such input channels is filtered for noise before being provided by the digitizer 102 to the controller 100 or another component (not shown). FIG. 2 shows processing of a signal received on one input channel of the digitizer 102. It should be apparent to one having skill in the art, that the components of FIG. 2 may be duplicated and operated in parallel to process signals received from additional channels. Further, it should be apparent to one of skill in the art that the digitizer 102 may provide samples of a signal received on a channel that is not selected for noise filtering to the controller 100 or another component (not shown) for display or further analysis.

The values of each digital data stream generated by the main ADC unit 206 by sampling the signal received on the input channel selected for noise filtering is scaled by a scaling and calibration unit 208. The scaling and calibration unit 208 applies a predetermined scaling factor to the values of the data stream developed by the main ADC unit 206. The scaling and calibration unit 208 may apply an offset to each value of the data stream to establish a correct zero crossing point for such data stream. In addition, the positive and negative components of such data stream may be scaled to correct for any imbalances between positive and negative gains in components of, for example, the test probe 104 and/or the digitizer 102. The data stream, referred herein as CH_DATA, developed by the scaling and calibration unit 208 of the main ADC unit 200 is provided to the ANC module 204.

As noted above, the digitizer 102 also includes a line ADC unit 202 that generates data streams representing reference sine and cosine waves. A line frequency ADC module 210 generates a line-source data stream by sampling the line power from the power unit 108. A 90° phase shifter module 212 applies a 90° phase shift to the samples generated by the ADC module 210 to generate a 90° phase shifted representation of the line-source data stream. A unity sine/cosine wave generator 214 estimates the frequency of the of the line-source data stream and generates a data stream REF_X that has values representing a sine wave having a frequency that is identical to the frequency of the line-source data or an integer multiple (i.e., a harmonic) of such frequency. Further, the sine wave represented by the values of the data stream REF_X has a phase identical to the line-source data stream. In one embodiment, the data stream REF_X represents a sine wave and unity-amplitude that spans 2-volts peak-to-peak (i.e., from −1-volt to +1-volt). The frequency of such sine wave is identical to the frequency of the line-source data stream if noise associated with fundamental frequency of the power line is to be filtered. Similarly, such frequency may be a particular harmonic frequency of such fundamental if noise associated with such harmonic frequency is to be filtered. In some embodiments, the operator may specify whether noise associated with the fundamental frequency, one or more harmonics of the fundamental frequency, or a combination thereof is to be filtered. It should be apparent to those of skill in the art that the elements shown in FIG. 2 may be duplicated to remove, in parallel, noise associated the fundamental frequency and/or one or more harmonic frequencies.

Referring once again to FIG. 2, the unity sine/cosine wave generator 214 also estimates the frequency of the 90° phase-shifted representation of the line-source data stream and generates a data stream REF_Y that has a frequency identical to the frequency of the sine wave represented by the data stream REF_X. The sine wave represented by the values of the data stream REF_Y has a unity amplitude and a phase identical to the 90° degree phase shifted data stream. It should be apparent to one of skill in the art that the data stream REF_X represents a sine wave and that the data stream REF_Y represents a cosine wave having a frequency and amplitude identical to such sine wave. The data streams REF_X and REF_Y are provided to the ANC unit 204.

The line ADC unit 202 also includes a zero-crossing data generator 216 that generates data regarding the zero-crossings of the line power from the power unit 108. Such zero-crossing data is also supplied to the ANC unit 204.

Referring to the ANC unit 204 of the digitizer 102, a band-pass filter module 218 of the ANC unit 204 receives the data stream CH_DATA and band pass filters such data stream. In some embodiments, the band-pass filter module may be an Infinite Impulse Response Filter such as a Butterworth Filter. In one embodiment, the band-pass filter may be a second-order Butterworth Filter. It should be apparent to one of skill in the art that the band-pass filter module 218 may use any type of band-pass filtering technique. The band-pass filter is configured to band-limit the data stream CH_DATA to include at least the frequency selected for REF_X and REF_Y above.

The data stream CH_DATA_BPL from the band-pass filter module 218 that results from band-pass limiting the data stream CH_DATA is provided to a correlation module 220. The correlation module 220 correlates the data stream CH_DATA_BPL with the data stream REF_X to develop a value Rxi. In some embodiments, the correlation module 220 autocorrelates the data stream CH_DATA_BPL with the data stream REF_X. Similarly, the correlation module 220 correlates the data stream CH_DATA_BPL with the data stream REF_Y to develop a value Ryi. As should be apparent to one having skill in the art, the value Rxi is an estimate of noise in the data stream CH_DATA_BPL when compared with data stream REF_X. Similarly, the value Ryi is as an estimate of noise in the data stream CH_DATA_BPL when compared with the data stream REF_Y. In some embodiments, the correlation module may use the zero-crossing data provided by the zero-crossing data generator 216 to synchronize the operation thereof.

Referring once again to FIG. 2, the values Rxi and Ryi developed by the correlation module 220 are provided to a gating module 224.

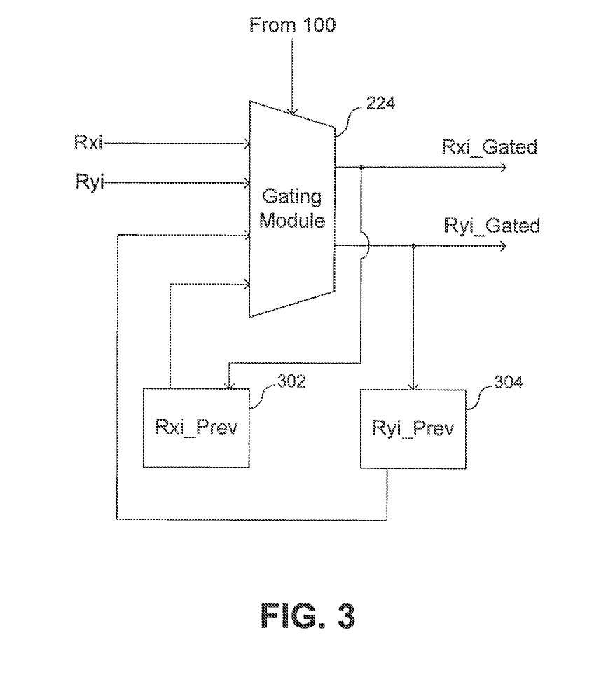

Referring to FIG. 3, the gating module 224 checks the gating signal from the controller 100 to determine if the values Rxi and Ryi were developed from a data stream CH_DATA_BPL that resulted from a signal from the test probe 104 acquired during a period without bioelectrical activity. If so, the gating module provides values Rxi_gated and Ryi_gated that are identical to the values Rxi and Ryi, respectively, to an averaging module 226. The gating module 224 also stores such values of Rxi_gated and Ryi_gated in memory locations 302 and 304, respectively. If the values Rxi and Ryi from the correlation module 220 are developed from a data stream CH_DATA_BPL that resulted from a signal acquired during a period of bioelectrical activity, the gating module 224 provides to the averaging module 226, FIG. 2, the values Rxi_gated and Ryi_gated that are identical to the values stored in the memory location 302 and 304, respectively.

In one embodiment, a gating signal that is held high indicates that the signal acquired by the test probe 104 may include transients due bioelectrical activity and a gating signal that is low may indicate that the signal acquired by the test probe 104 does not include transients due to bioelectrical activity. It should be apparent in other embodiments that a gating signal that is low may indicate acquisition of a signal during a period of bioelectrical activity and a gating signal that is high may indicate acquisition of a signal when there is no bioelectrical activity. Other ways of indicating to the gating module 224 whether a signal was acquired during a period of bioelectrical activity will be apparent to those who have skill in the art.

Referring once again to FIG. 2, the averaging module 226 calculates a moving average of a predetermined quantity of the values Rxi_gated most recently generated by the gating module 224 to develop a value Rxi_avg. Similarly, the averaging module calculates a moving average of the value Ryi_gated most recently generated by the gating module 224 to develop a value Ryi_avg. In some embodiments the predetermined quantity may be set to a particular value, for example ten. In other embodiments, the predetermined quantity may be user configurable. As should be apparent, such predetermined quantity of values received from the gating module 224 is selected to introduce hysteresis in the ANC unit 204 so that the effects of spurious noise on noise filtering may be minimized.

The values Rxi_avg and Ryi_avg are provided to a reconstruction module 228 that uses such values to estimate the noise component of the data stream CH_DATA and remove such noise component from the data stream CH_DATA.

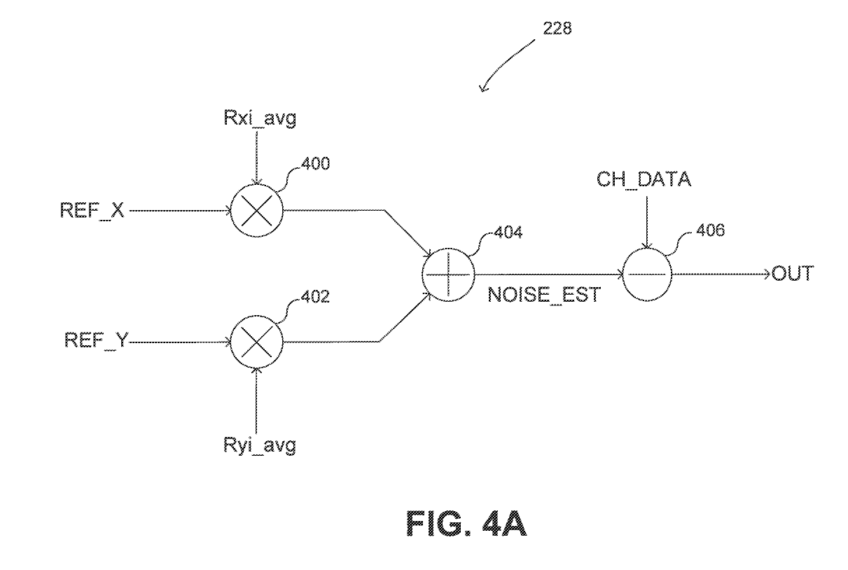

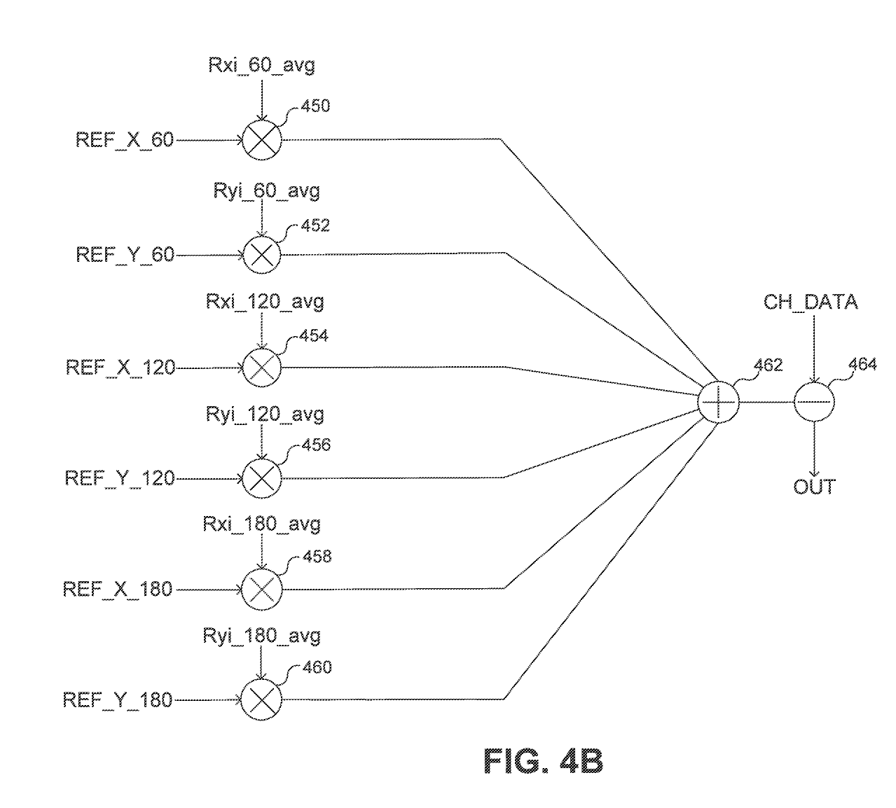

Referring to FIG. 4A, a multiplier 400 multiplies each value of the data stream REF_X with the value Rxi_avg. A multiplier 402 multiplies each value of the data stream REF_Y with the value Ryi_avg. The products generated by the multipliers 400 and 402 are summed by an adder 404 to produce a noise estimate data stream NOISE_EST. A subtractor 406 subtracts each value of the data stream NOISE_EST from a corresponding value of the data stream CH_DATA to develop a data stream OUT that is the output of the digitizer 102. Such data stream OUT is provided to the controller 100 or other component (not shown) for display and/or further analysis.

In one embodiment, the digitizer 102 is configured to remove noise associated with fundamental and selected harmonic frequencies by cycling through each such frequency. For example, if the digitizer 102 is to remove noise associated with 60 Hz, 120 Hz, and 180 Hz (i.e., the fundamental frequency and first and second harmonics of the fundamental frequency), the unity sine/cosine wave generator 214 generates REF_X and REF_Y data streams for 60 Hz (referred herein as REF_X_60 and REF_Y_60), then in turn generates REF_X and REF_Y for each of 120 Hz (referred herein as REF_X_120 and REF_Y_120) and 180 Hz (referred herein as REF_X_180 and REF_Y_180). The correlation unit 220 correlates the CH_DATA with each of the REF_X_60, REF_Y_60, REF_X_120, REF_Y_120, REF_X_180, and REF_Y_180 data streams. Such correlation produces values Rxi_60, Rxi_120, and Rxi_180 associated with 60 Hz, 120 Hz, and 180 Hz, respectively. The correlation also produces values Ryi_60, Ryi_120, and Ryi_180 associated with 60 Hz, 120 Hz, and 180 Hz, respectively.

The values Rxi_60, Ryi_60, Rxi_120, Ryi_120, Rxi_180, Ryi_180 are gated by the gating module 224 to produce corresponding gated values Rxi_60_gated, Ryi_60_gated, Rxi_120_gated, Ryi_120_gated, Rxi_180_gated, and Ryi_180_gated. A moving average of such gated values is developed by the averaging unit 226 as described above to produce corresponding values Rxi_60_avg, Ryi_60_avg, Rxi_120_avg, Ryi_120_avt, Rxi_180_avg, and Ryi_180_avg.

Referring to FIG. 4B, a multiplier 450 multiplies the value Rxi_60_avg with each value of the data stream REF_X_60. Similarly, multipliers 452, 454, 456, 458, and 460 multiply the values Ryi_60_avg, Rxi_120_avg, Ryi_120_avg, Rxi_180_avg, and Ryi_180_avg, respectively, with each value of the corresponding data streams REF_Y_60, REF_X_120, REF_Y_120, REF_X_180, and REF_Y_180. The data streams that result from such multiplications are added by a summer 462 and subtracted from the data stream CH_DATA by subtractor 464. The result of such subtraction is generated as an output data stream of the digitizer 102. Although, removal of noise associated with three frequencies is described in the foregoing, it should be apparent to one having skill in the art that noise associated with more or fewer number of frequencies may be removed in a similar manner.

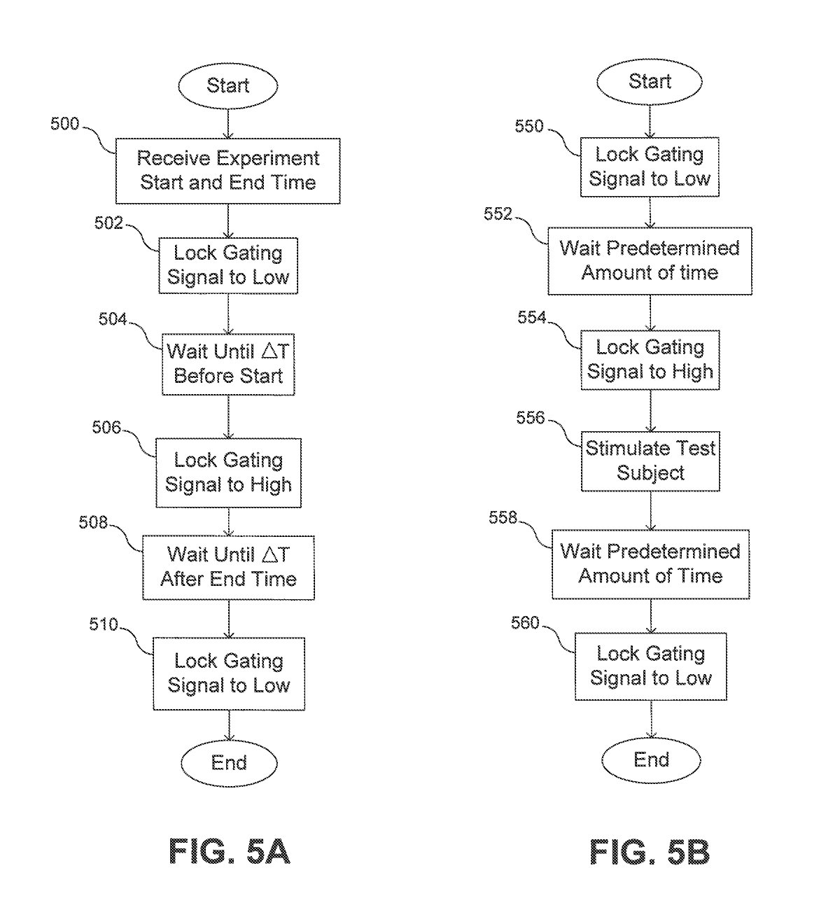

Referring to FIG. 5A, a flowchart is illustrated of the processing undertaken by the controller 100 to generate the gating signal. The flowchart illustrated in FIG. 5A assumes that a gating signal that is low indicates a period without bioelectrical activity and a gating signal that is high indicates a period with bioelectrical activity. At step 500, the controller 100 receives experimental parameters including when an experiment is to start and end. At step 502, the controller locks the gating signal low to indicate that no bioelectrical activity is occurring. At step 504, the controller waits until a predetermined duration of time AT before the start of the experiment.

Referring also to FIG. 2, during the time period between the steps 502 and 504, the test probe 104 provides a signal to the digitizer 102. The digitizer 102 operates as described above. In particular, the gating module 224 provides Rxi and Ryi values generated by the correlation unit 220 as values of Rxi_gated and Ryi_gated to the averaging module 226. In this fashion, the ANC unit 204 of the digitizer 102 operates in an adaptive mode to learn the characteristics of the noise present in the signal from the test probe 104 when there is no bioelectrical activity.

At step 506, the controller 100 locks the gating signal to high. In response, the ANC unit 204 operates in a fixed (i.e., non-adaptive mode) and the gating module 224 supplies the values stored in the memories 302 and 304 as values of Rxi_gated and Ryi_gated to the averaging module 226. Further, the gating module 224 does not update the memories 302 and 304 with new values of Rxi and Ryi developed by the correlation unit 220.

At step 508, the controller waits until a predetermined amount of time ΔT has elapsed after the expected end time of the experiment. It should be apparent to one of skill in the art that the predetermined amount of time ΔT before the start of the experiment and the predetermined amount of time ΔT after the end of the experiment noted in steps 504 and 508 need not be identical.

At step 510, the controller locks the gating signal to low and exits.

FIG. 5B shows a flowchart of processing undertaken by another exemplary embodiment of the controller 100. At step 550 the controller 100 locks the gating signal to low and at step 552 waits for a predetermined amount of time to elapse. During this period the ANC unit 204 operates in an adaptive mode in response to signals received from the test probe 104.

At step 554 the controller 100 locks the gating signal to high. The ANC unit 204 transitions into the fixed operating mode as described above.

At step 556 the controller 100 generates a stimulus to a test subject being monitored using the test probe 104. In some experiments, the bioelectrical signal generated by the test subject in response to such stimulus is the signal of interest. At step 558, the controller 100 waits for a predetermined amount of time. At step 560, the controller 100 locks the gating signal to low and exits. It should be apparent that controller 100 may not undertake the step 510 or 560 to return the gating signal to low.

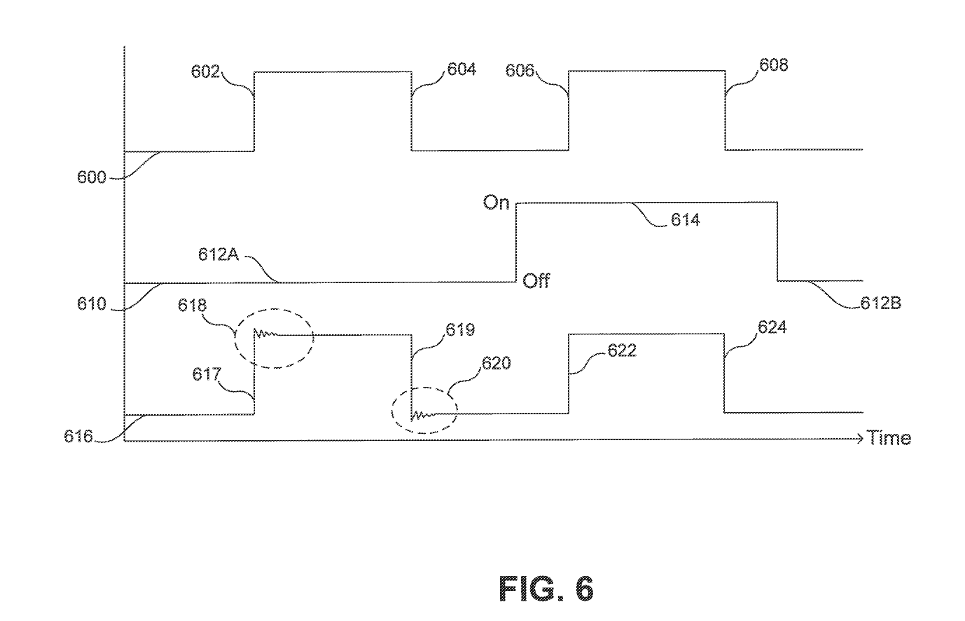

Referring to FIG. 6, a trace 600 depicts an input signal from the test probe. The trace 600 shows that the input signal includes sudden transitions 602, 604, 606, and 608. A trace 610 illustrates the gating signal generated by the controller 100. The gating signal has portions 612A,B that are low and a portion 614 that is high. For purposes of FIG. 6, a low gating signal indicates a period without bioelectrical activity and a high gating signal indicates a period with bioelectrical activity. A trace 616 depicts the output generated by the digitizer 102.

As described above, during the time period when the gating signal is low (i.e., portions 612A,B), the ANC unit 204 operates in an adaptive mode. In such mode, the ANC unit 204 takes time to adapt to the signal level after the transients 602 and 604. During such adaptation time, the output generated by ANC unit 204 may include artifacts 618 and 620 immediately following the transitions 617 and 619 associated with the transitions 602 and 604 in the input signal

During the time period when the gating signal is high (i.e., portion 614), the ANC unit 204 operates in a fixed mode. Therefore, as shown in the trace 616, no artifacts are created by the ANC unit 204 following the transitions 622 and 624 associated with transitions 606 and 608 of the input signal.

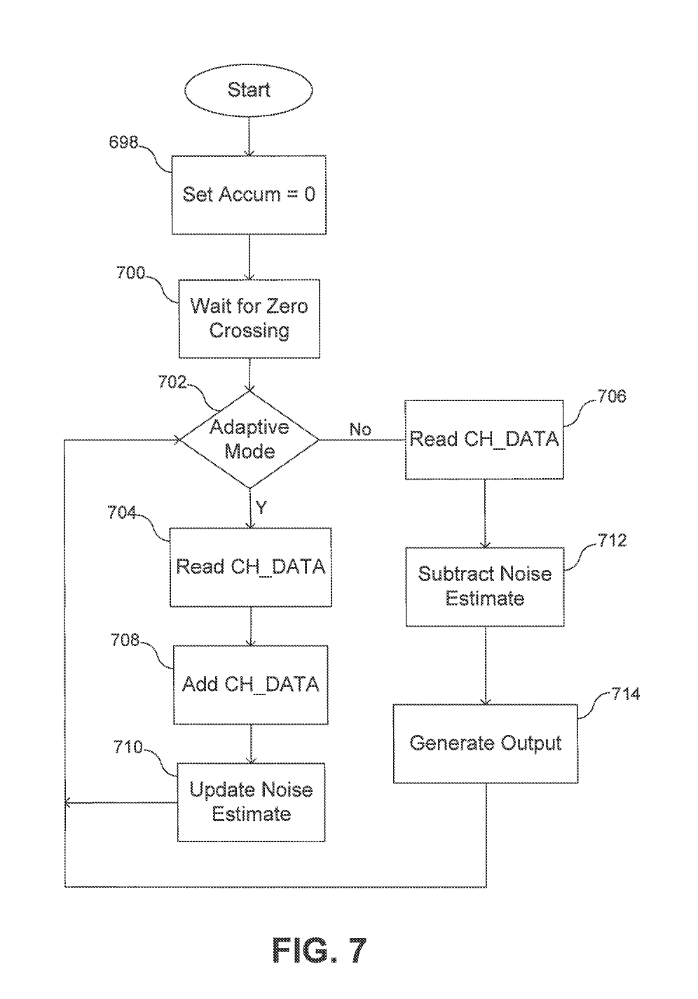

FIG. 7 is a flowchart of another embodiment of an ANC unit 204 that may operate in either an adaptive mode or a fixed mode in accordance with a gating signal. At step 698, the ANC unit each value of an accumulation buffer. The accumulation buffer includes one value of each sample that may be generated in one power cycle. For example, at 60 Hz and 500 KSPS, the accumulation buffer includes 8,333 values.

At step 700, the ANC unit 204 waits until a zero crossing is detected from the zero crossing generator 216. At step 702 the ANC unit 204 checks the gating signal to determine if the ANC unit 204 should operate in adaptive mode. If so, the ANC unit 204 proceeds to step 704. Otherwise the ANC unit 204 proceeds to step 706 to operate in fixed mode.

At step 704 the ANC unit 204 reads the CH_DATA data stream developed by the main ADC unit 200 that has samples of one power cycle of the input signal provided by the test probe 104. In some embodiments, the ANC unit 204 may sequentially read the value of the CH_DATA data stream and accumulate sufficient data to represent one cycle of the power line. In other embodiments, the main ADC unit 200 may store CH_DATA data stream in a circular buffer as such data stream is developed and the ANC unit 204 may read from the circular buffer asynchronously.

At step 708, the ANC unit 204 adds the values of CH_DATA read at step 704 to corresponding values of the accumulation buffer.

At step 710, the ANC unit 204 develops a noise estimate data stream NOISE_EST, wherein each value of the data stream is the result of dividing a corresponding value of the accumulation buffer by the number of cycles accumulated in such buffer.

After step 708, the ANC unit 204 returns to the step 702.

At step 706, the ANC unit 204 reads one power cycle of the CH_DATA data stream. At step 712, the ANC unit 204 subtracts from each value of the CH_DATA read at step 706, a corresponding value from the data stream NOISE_EST developed at step 710.

At step 714 the ANC unit 204 provides the result of the subtraction at step 712 as an output of the digitizer 102. After step 714 the ANC unit 204 returns to the step 702.

It will be understood and appreciated that one or more of the processes, sub-processes, and process steps described in connection with FIGS. 1-7 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules schematically depicted in FIGS. 1-7. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., ADC units 200 and 202, the band-pass filter module 218, the correlation unit 220, the averaging module 226, the gating module 224, and the reconstruction module 228 of FIG. 2), which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system, direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that receiving and transmitting of signals as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A method of removing noise from a bioelectrical signal, comprising:
receiving a main analog signal from a bioelectrical test probe;
receiving a gating signal;
developing a main data stream associated with the main analog signal from the bioelectrical test probe;
developing an output data stream by removing estimated noise components from the main data stream; and
updating the estimated noise components in accordance with the main signal only if the gating signal indicates that the main analog signal was acquired during a period without bioelectrical activity.

2. The method of claim 1, further comprising:
receiving a line analog signal representing line power frequency;
developing a reference data stream associated with the analog signal representing a frequency of interest to minimize; and
wherein developing the output stream includes removing the estimated noise components associated with the frequency of interest from the main data stream in accordance with the reference data stream.

3. The method of claim 2, further comprising developing a phase-shifted version of the reference data stream and the output data stream is developed in accordance with the phase-shifted reference data stream.

4. The method of claim 2, further comprising developing a noise estimate value from the main data stream and the reference data stream and, if the gating signal indicates the main analog signal was acquired during a period without bioelectrical activity then storing the noise estimate value.

5. The method of claim 4, wherein developing the output stream includes (1) using the developed noise estimate value to remove the noise component from the main data stream if the gating signal indicates the main analog signal was acquired during a period without bioelectrical activity, and (2) using a previously stored noise estimate value to remove the noise component from the main data stream if the gating signal indicates the main analog signal was acquired during a period of bioelectrical activity.

6. The method of claim 2, further comprising sequentially developing a further reference data stream associated with an analog signal representing a further frequency of interest to minimize.

7. The method of claim 2, wherein the steps of the method are performed simultaneously on a further analog signal from a further bioelectrical test probe.

8. The method of claim 1, further comprising developing an average of the values of the main data stream when the gating signal indicates that the main analog signal was acquired during a period without bioelectrical activity.

9. The method of claim 8, wherein developing the output data stream includes subtracting an average of previously accumulated values of the main data stream from the main data stream if the gating signal indicates that the main analog signal was acquired during a period of bioelectrical activity.

10. The method of claim 1, wherein the steps of the method are undertaken substantially concurrently and in real time.

11. An apparatus for removing noise from a bioelectrical signal, comprising:
a main analog-to-digital converter (ADC) unit that develops a main data stream from a main analog signal received from a bioelectrical test probe;
a gating module that receives a gating signal;
an adaptive noise cancellation (ANC) unit that develops an output data stream by removing estimated noise components from the main data stream; and
wherein the ANC unit updates the estimated noise components in accordance with the main signal only if the gating signal indicates that the main analog signal was acquired during a period without bioelectrical activity.

12. The apparatus of claim 11, further comprising:
a line ADC unit that develops a reference data stream from a line analog signal received from a line power source, wherein the reference data stream represents a frequency of interest to minimize; and
wherein the ANC unit develops the output data stream by removing the estimated noise components associated with the frequency of interest from the main data stream in accordance with the reference data stream.

13. The apparatus of claim 12, wherein the line ADC unit further develops a phase-shifted version of the reference data stream and the ANC unit develops the output data stream in accordance with the phase-shifted reference data stream.

14. The apparatus of claim 12, wherein the ANC unit develops the noise estimate value from the main data stream and the reference data stream, and stores the noise estimate value if the gating signal indicates the main analog signal was acquired during a period without bioelectrical activity.

15. The apparatus of claim 14, wherein the ANC unit (1) uses the developed noise estimate value to remove the noise component from the main data stream if the gating signal indicates the main analog signal was acquired during a period without bio electrical activity, and (2) uses a previously stored noise estimate value to remove the noise component from the main data stream if the gating signal indicates the main analog signal was acquired during a period of bioelectrical activity.

16. The apparatus of claim 12, wherein the line ADC unit develops a further reference data stream associated with an analog signal representing a further frequency of interest to minimize.

17. The apparatus of claim 12, wherein main ADC unit simultaneously develops a further main data stream from a further analog signal received from a further bioelectrical test probe, and the ANC unit simultaneously removes further estimated noise components from the further main data stream.

18. The apparatus of claim 11, wherein the ANC unit further develops an average of the values of the main data stream when the gating signal indicates that the main analog signal was acquired during a period without bioelectrical activity.

19. The apparatus of claim 18, wherein the ANC unit develops the output data stream by subtracting an average of previously accumulated values of the main data stream from the main data stream if the gating signal indicates that the main analog signal was acquired during a period of bioelectrical activity.

20. The apparatus of claim 11, wherein the main ADC unit and the ANC unit operate substantially concurrently and in real time.
